(19) United States
(12) Patent Application Publication
(10) Pub. No.: US 2001/0013721 A1
(43) Pub. Date: Aug. 16, 2001

(54) Wheels for use in wheelchairs and two-wheeled vehicle

(76) Inventor: Shigeyuki Ishii, Chiba-shi (JP)

Correspondence Address: BRUCE LONDA, NORRIS, MCLAUGHLIN & MARCUS, P.A., 220 EAST 42ND STREET, 30TH FLOOR, NEW YORK, NY, 10017, US

(21) Appl. No.: 09/750,881

(22) Filed: Dec. 28, 2000

(30) Foreign Application Priority Data
Jan. 4, 2000 (JP) 2000-60

(51) Int. Cl. B60B 1/06

(52) U.S. Cl. 301/79

(57) ABSTRACT

A wheel for use in wheelchairs, or two-wheeled vehicles, having a rim around which a tire is mounted, a hub being located in a center portion of the rim, and spokes being held between the rim and the hub; the spokes have a plate-like shape.

### BACKGROUND OF THE INVENTION

1) Field of the Invention

The present invention relates to wheels for use preferably in wheelchairs and two-wheeled vehicles. According to the present invention, both the manufacturing steps at the manufacturer's side and the usefulness at the user's side are improved.

2) Related Art

The conventional wheel used for wheelchairs or two-wheeled vehicles are constituted of a rim for mounting a tire, a hub located in the center of the rim, and a plurality of spokes having a rod-like shape arranged between the rim and the hub. The rim is supported around the hub via the spokes having a rod-like form so that a desired stiffness can be obtained. Each spoke having a rod-like form is held between the hub and the rim in such a manner that one end of the spoke is fixed to the inner circumference of the rim and the other end is to the hub. Then the wheel is consigned for sale after the tension of each spoke is achieved. The spokes are fixed to holes made in the inner circumference of the rim; each spoke is held in its place with a nut having a flange, so called “nipples”. While, at the hub side, holes are made in the outer circumference of the hub in which the other end of each spoke is inserted and held there. The spokes are bent to be placed between the rim and the hub.

The conventional wheel, where such spokes having a rod-like form are held between the rim and the hub, have drawbacks mentioned below.

The wheel using rod-type spokes, are required to provide many spokes and the tension of each of the spokes must be adjusted one by one. Therefore, many assembling steps and much time are required in order to manufacture the conventional wheel with spokes having a rod-like form. Further, since the tension of the spokes must be adjusted one by one, it is difficult to obtain the desired stiffness of a wheel. Furthermore, it is necessary to make the number of the holes the same to that of the spokes in the inner circumference of the rim in a radial direction, causing the design and the material for the rim to be is limited and thus the design of the wheel as a whole is also limited.

### SUMMARY OF THE INVENTION

The present invention has for its purpose to provide a wheel which can be manufactured easily, the design and the material of the rim and the wheel as a whole are not limited, in addition, the usefulness is to the user be improved.

In order to solve the previously mentioned drawbacks, a wheel according to the present invention comprises a rim for mounting a tire on the outer circumference thereof, a hub being located in a center portion of said rim, and a plurality of spokes having a plate-like form being held between the rim and the hub.

In this manner, according to the present invention, spokes having a plate-like form are used instead of spokes having rod-like forms as in conventional wheels. Therefore, fewer number of spokes are required in comparison to conventional wheels; there is no necessity to make holes in the inner circumference of the rim in order to hold the spokes to the rim; therefore the manufacturing steps of the wheels becomes simpler and the adjustment of the tension of the spokes becomes so easy.

The wheel according to the present invention has a second aspect in that the wheel comprises a rim for mounting a tire on the outer circumference thereof, a hub being located in the center portion of the rim, and a plurality of spokes having a plate-like form being held between the rim and the hub, wherein said spokes having a plate-like form are held between the hub and the rim in a detachable manner.

By using spokes having a plate-like shape, the spokes can be arranged to be detachable with respect to the rim or the hub. In addition to this, the spokes being made of a different material or having a different design can be freely used, because the spokes are detachable. Therefore, the wheel can be easily exchanged depending on the individual purpose or the choice by the user of a wheelchair or a two-wheeled vehicle. This aspect is particularly preferred in the case that the wheel according to the invention is applied to wheelchairs. Because, for the user of a wheelchair, the using condition should be adjusted depending upon the degree of the handicap, and the stiffness or other characters of the wheels greatly influences the user's convenience in using the wheelchair.

The wheel according to the present invention has another aspect in that the length of the hub is adjustable in its axial direction. The adjustment is conducted in such a manner that a hub is selected from a plurality of hub members each having a different length in its axial direction. Furthermore, the adjustment can also be conducted in such a manner that the hub comprises at least a hollowed cylindrical member and outer members to be connected to both sides of the cylindrical member; the connected portion of the hollow cylindrical member and the outer members is arranged to be adjusted.

Since the length of a hub in its axial direction is adjustable in this manner, the tension of the spokes can easily be changed in one step and in an even manner.

Furthermore, the wheels according to the present invention comprise protruded portions on the inner circumference of the rim for assembling a hand rim there, and the hand rim is fixed to the protruded portions by means of connecting members.

According to the present invention, since each wheel has spokes having a plate-like shape, it is possible to make the number of spokes fewer in comparison to the conventional wheels, which use spokes having a rod-like shape. The spokes having a plate-like form do not spread over the rim as a whole and then the protruded portions for assembling a hand rim can be provided in the rest portion of the inner circumference of the rim, where no spokes having a plate-shape are arranged. According to the invention, the hand rim can be assembled to the protruded portions by means of connecting members, which is easier than the conventional method, where the hand rim must be attached to the wheel by welding. Further, since the hand rim may be detachable from the wheel according to the invention, the hand rim can be exchanged so as to meet the individual purpose of the user.

### BRIEF DESCRIPTION OF THE DRAWINGS

FIG. 1 is a cross-sectional view in a vertical direction showing a wheel according to the first embodiment of the present invention;

FIG. 2 is a front view of the wheel shown in FIG. 1;

FIG. 3 is a schematic view depicting the part A in FIG. 1 on an enlarged scale;

FIG. 4 is a schematic view illustrating the part B in FIG. 1 on an enlarged scale;

FIG. 5A is a plan view representing the left part of a wheel according to the second embodiment of the present invention;

FIG. 5B is a cross-sectional view in a vertical direction showing the left part of a wheel according to the second embodiment of the present invention;

FIG. 6A is a schematic view depicting a hub shown in FIG. 5A and FIG. 5B in an exploded manner;

FIG. 6B is a schematic view illustrating the hub in an assembled manner;

FIG. 7A is a schematic view representing another hub in an exploded manner;

FIG. 7B is a schematic view showing the hub represented in FIG. 7A in an assembled manner;

FIG. 8A is a front view depicting the left part of a rim which is applied to a wheel for a wheelchair; and

FIG. 8B is a right side view illustrating the rim depicted in FIG. 8A.

### DETAILED DESCRIPTION OF THE PREFERRED EMBODIMENTS

Preferred embodiments according to the present invention will be explained below, referring to the attached drawings.

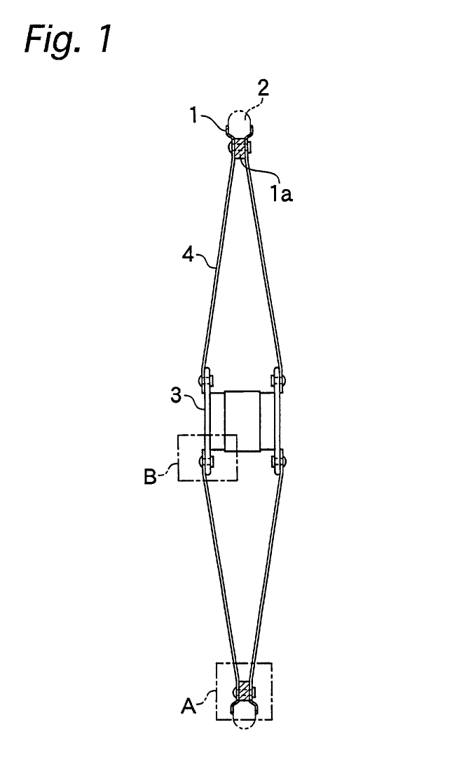

FIGS. 1 to 4 show a wheel according to the first embodiment, which is for use in wheelchairs. The wheel comprises a rim 1, on the outer circumference of which a tire 2 is mounted, a hub 3 located in the center of the rim 1, and spokes 4 held between the rim 1 and the hub 3. On the one side of the circumference of the rim 1, a hand rim, which will be explained below, is attached to constitute of a driving wheel for use in a wheelchair.

According to the present invention, each spoke 4 has a plate-like shape and is arranged between the rim 1 and the hub 3, constituting one of a pair.

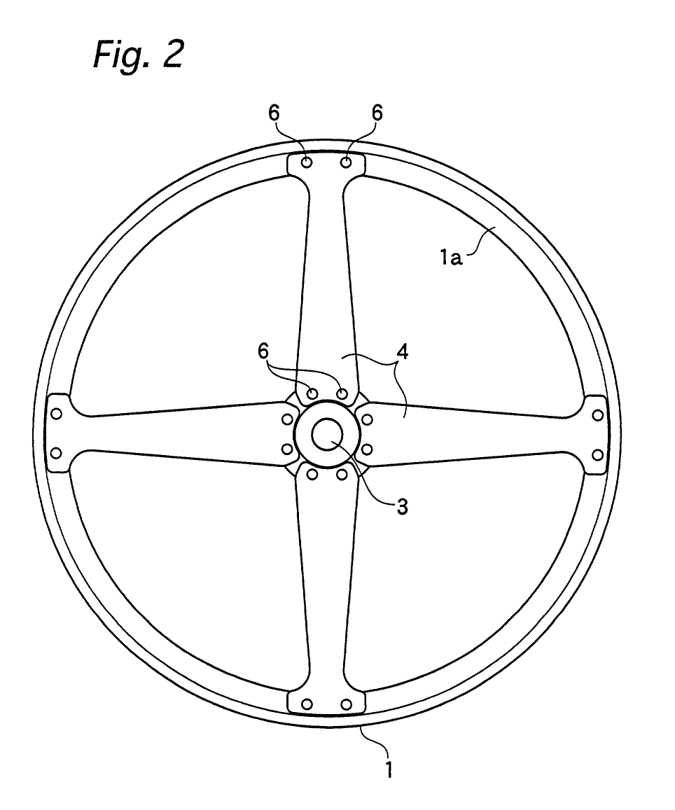

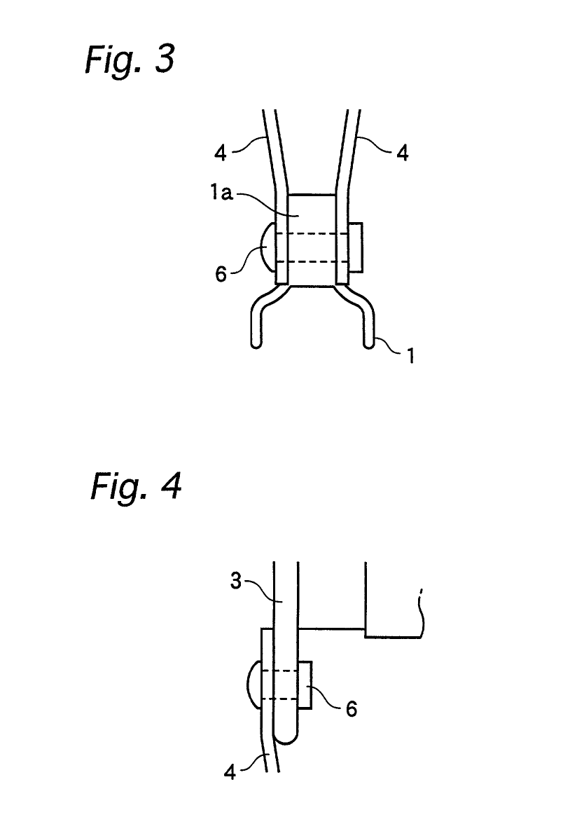

That is to say, each plate-like shaped spoke 4 is constituted of a plate-like member having a significant thickness and width; a pair of plate-like members are arranged to face each other together, being arranged on both sides of the hub 3. According to the present embodiment, four pairs of plate-like shaped spokes 4 are arranged between the rim 1 and the hum 3 at 90 degrees as shown in FIG. 2. The material of the plate-like shaped spokes 4 is not particularly specified, however, aluminum, titanium, other metals, carbon, synthetic resin, etc. can be preferably used. The plate-like shaped spokes 4, whose cross-sectional views are shown in FIGS. 1 and 3, are held between the rim 1 and the hub 3 in such a manner that one of the ends of the spoke 4 is fixed to the outer surface of the inner circumference 1a of the rim 1 by means of two rivets 6, while the other end of each spoke 4 is fixed to the outer surface of the outer circumference of the hub 3 by means of two rivets 6, as shown in FIGS. 1 and 4. Depending on the thickness of the hub 3, a suitable tension is given to each spoke 4; thereby the desired stiffness and spring effect for a wheel among the rim 1, the plate-state spokes 4, and the hub 3 can be obtained. It should be noted that holes (not shown) are provided within the inner circumference 1a of the rim 1, the outer circumferences of both ends of the hub 3, and both ends of the plate-like shaped spokes 4 for inserting the rivets.

Such a wheel has advantages to a conventional wheel using spokes having a rod-like form. That is to say, the spokes having a plate-like form are used in the condition of a pair; only several pairs (four pairs in this embodiment) of plate-like shaped spokes are required to be used, and a certain tension can be obtained by only attaching several pairs of the plate-like shaped spokes 4 to the rim 1 and the hub 3. Therefore, the number of manufacturing steps of a wheel becomes fewer, and the wheels can be assembled in a short time period. Further, the spoke itself has the advantage in easily being processed, because it has a plate-like shape. Further, many different designs are applicable to the design of spokes 4 and the material of the spokes can be freely selected in accordance to the purpose of use.

Furthermore, by using the plate-like shaped spokes 4, the spokes can be brought to surface-contact to the rim 1 and the hub 3 by means of rivets, etc. Therefore, it becomes unnecessary to make holes in the rim itself in a radius direction, so that the structure of the rim itself becomes simple. Moreover, a tubeless tire 2 can be mounted on the rim 1, which has the advantage that the tire can easily be repaired in case of bursting.

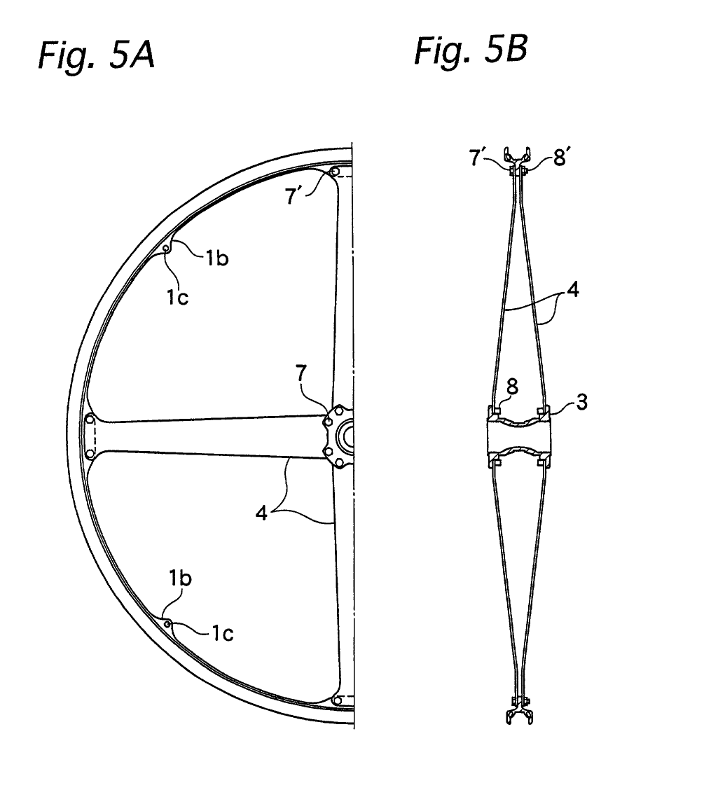

FIGS. 5 to 7 show a wheel used for a wheelchair according to the second embodiment of the present invention. In the second embodiment, pairs of the plate-like shaped spokes 4 are used and the spokes 4 are arranged to be detachable with respect to the rim 1 and the hub 3.

That is to say, one of the ends of the plate-like shaped spoke 4 is fixed to both the outer sides of the rim by means of a bolt 7′ and a nut 8′, while the other end of the plate-like shaped spokes 4 is fixed to the hub 3 by means of a bolt 7 and a nut 8. In this case, at the rim 1 side, the pair of plate-like shaped spokes facing together are attached to the rim 1 and tightened simultaneously by means of the bolt 7 and the nut 8.

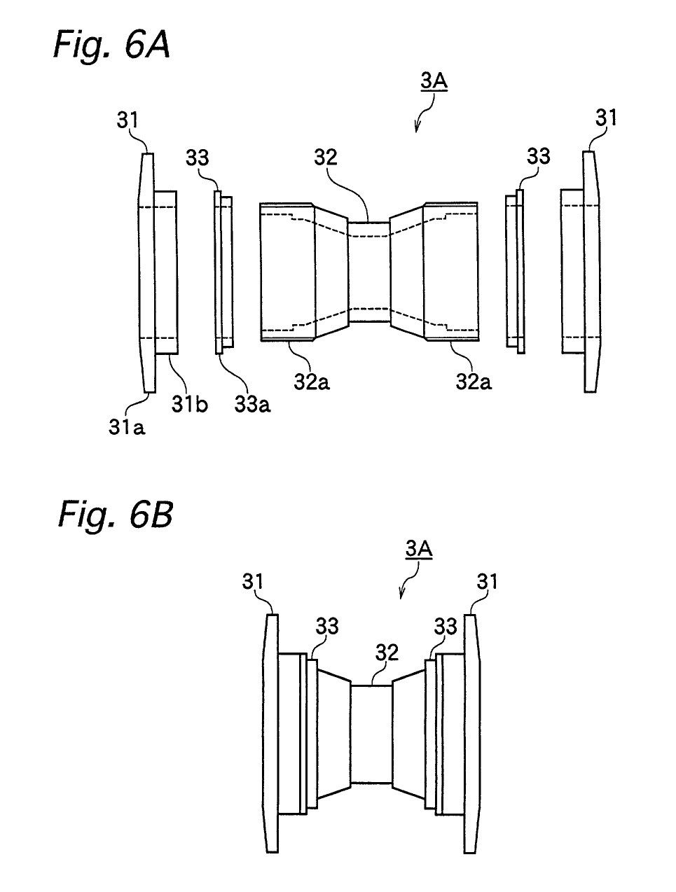

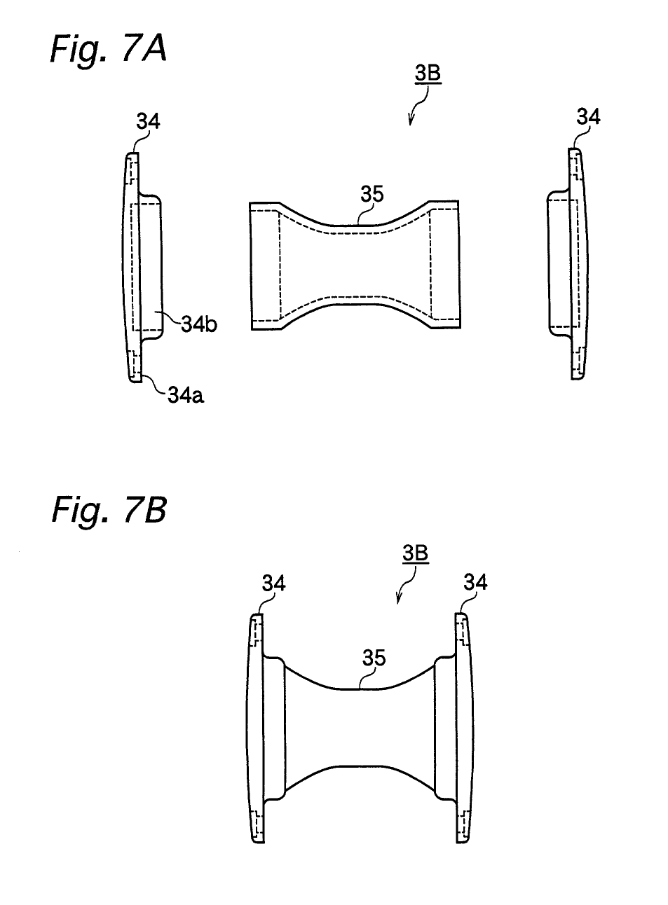

FIGS. 6 and 7 show a construction of the hub 3. As shown in these figures, the hub 3 is constituted of plural parts, so that the length of the hub in an axial direction can be adjusted by exchanging any one of the parts.

The hub 3A shown in FIGS. 6A and 6B comprises two outer pieces 31, 31, a hollowed cylindrical piece 32 provided between the outer pieces, spacers 33, 33 arranged between the outer pieces 31, 31 and both the ends of the cylindrical piece 32, respectively. Each outer piece 31 (31) comprises a flange 31a on the outer side thereof; so that the plate-like shaped spokes 4 are attached to the flange 31a. On the inner surface of the outer piece 31, a female thread 31b is provided in its axial direction, which is engaged to the male screw 32a provided on both ends of the outer surface of the cylindrical piece 32. There are provided holes (not shown) for inserting the bolt 7 in the flange 31a to fix the spokes 4. Each spacer 33 also comprises a flange 33a on the outer end thereof; the flange 33a is urged against the inner end of the outer piece 31. On the inner surface of the flange 33a, a female thread (not shown) to fit to the male screw 32a is provided on both ends of the cylindrical piece 32, as well as to the outer piece 31. By engaging both the ends of the hollowed cylindrical portion 32 to the spacer 33 and the outer piece 31, respectively, the hub 3A is assembled as shown in FIG. 6B. It should be noted that another hub (not shown here) is held in the hub 3A in a freely rotatable manner via a bearing (not shown).

The hub 3B shown in FIGS. 7A and 7B is an alternative for the hub 3A in FIGS. 6A and 6B. The hub 3B comprises two outer pieces 34, 34 and a hollowed cylindrical piece 35 provided between the outer pieces34, 34. Each outer piece 34 comprises a flange 34a on its outer end, and comprises a hole 34b inside to be engaged with the cylindrical piece 35. Both ends of the cylindrical piece 35 are engaged into the outer pieces 34, respectively, so that the completed hub 3B shown in FIG. 7B is obtained.

In the hub 3A shown in FIGS. 6A and 6B, at least one of the piece, out of the outer piece 31, the spacer 33, or the cylindrical piece 32, is arranged to be exchangeable. Several kinds of exchangeable pieces, which have a different length in their axial direction, are prepared; the length of the hub as a whole is then variable in its axial direction by exchanging the piece. While, in the hub 3B in FIGS. 7A and 7B, either one of the cylindrical piece 35 or the outer piece 34 is arranged to be exchangeable; several kinds of the exchangeable pieces, which have different lengths in an axial direction, are prepared; so that the length of the hub 3B as a whole becomes variable in an axial direction by exchanging any of the pieces.

According to the manufacturing convenience, it is desired to prepare several kinds of cylindrical pieces 32 (or 35) having different lengths in their axial direction of the hub; one of the cylindrical pieces 32 (35) is then selectively used so as to obtain a tension of the wheel satisfying each requirement of the user. In the embodiments shown in FIGS. 6A, 6B, 7A and 7B, it is arranged to change the length of the hub in an axial direction by exchanging the cylindrical piece (32 or 35). However, it may be possible to arrange such that the construction of the threads connecting the cylindrical piece (32 or 35) and outer pieces (31 or 34) are opposite to each other at the both ends of the cylindrical piece, so that the length of the hub in an axial direction can be adjusted by rotating the cylindrical piece (32 or 35).

In this manner, the tension of the plate-like shaped spokes 4 can be easily adjusted by changing the length of the hub 3 in an axial direction, so that the tension and the spring effect of each wheel as a whole can be varied easily and arbitrarily. Particularly, in case of wheelchairs, this point is extremely advantageous to each handicapped user from the point of view that the convenience is very different for each handicapper person. It should be noted that the tension of a wheel according to the invention can be also adjusted by putting a washer between the bolt 7 and the nut 8, which connect the plate-state spoke 4 to the hub 3. This means that it is possible to obtain a suitable tension not only by the wheel maker but also by the user's themselves.

Further, it is preferred to manufacture the wheel in such a manner that the hub 3, the plate-state spokes 4 and the outer piece (31, 34) are put together first, then the cylindrical piece (32, 35) and the spacer (33) are inserted; the spokes are then spread in an axial direction in an even manner. Thus, there is no need to determine the center of the wheel itself so that manufacturing the wheel becomes easier.

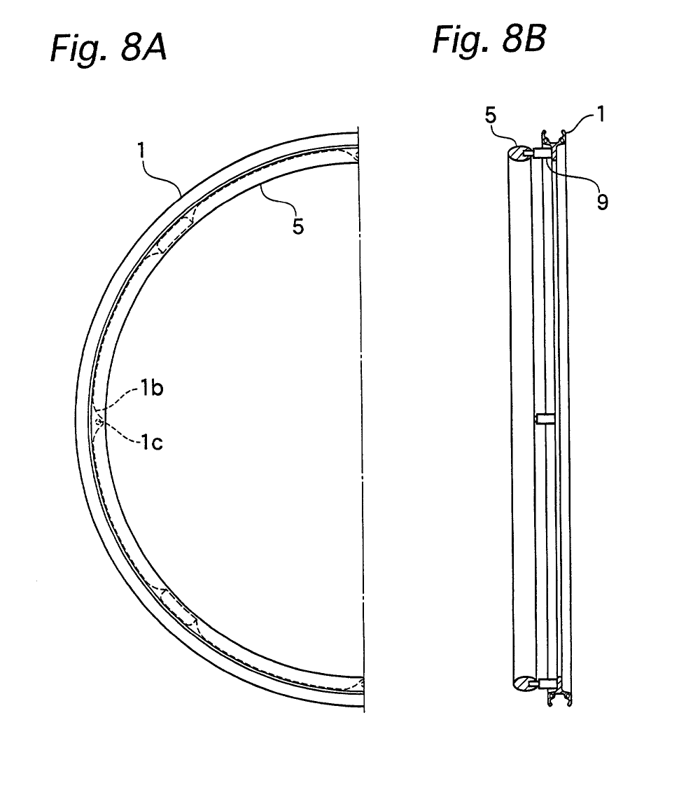

FIGS. 8A and 8B show a condition that a hand rim for use in a wheelchair is attached to the wheel according to the present invention. On the inner circumference of the rim 1, the protruded portion 1b for supporting the hand rim 5 is provided toward the center of the rim 1. In the protruded portion 1b, holes for mounting the hand rim 1 are made. As shown in FIG. 8A, four protruded portions 1b are provided on the inner circumference of the rim 1 with a distance of 90 degrees between the plate-like shaped spokes 4 so as not to interfere the plate-like spokes 4. The protruded portion has a wave-like shape toward the center of the wheel.

Further, the hand rim 5 is attached to the rim 1 by means of connecting members 9 as shown in FIG. 8B. On the outer circumference of the hand rim 5 at the rim 1 side, threaded holes are provided; while on one of the ends of the connecting members 9, screws are provided to be engaged with the holes of the hand rim 5. The other ends of the connecting members 9 have a shape, which is insertable through the hole 1c provided in the protruded portion 1b of the rim 1.

The hand rim 5 is attached to one of the inner circumference sides of the rim 1 with a certain distance in such a manner that one of the ends of the connecting member 9 is engaged to the hand rim 5 and the other end of the connecting portion 9 is inserted into the hole 1c provided in the protruded portion 1b of the rim 1 and is tighten to the rim by means of a tightening member such as a nut.

As mentioned above, according to the present invention, it is not necessary to arrange a plurality of rod-like shaped spokes to the rim. Therefore, the hand rim can be easily attached to the rim 1 by providing a hub (protruded portion) 1b on the rim 1 for fixing the hand rim thereto.

According to the conventional technique, it is impossible to provide such hubs on the rim because of the existence of many spokes having a rod-like shape; the hand rim should therefore be fixed to the rim by welding and unifies the hand rim with the rim. Thus, the user is forced to exchange the wheel as a whole in order to obtain a suitable hand rim for himself or herself. According to the invention, the users can select a suitable hand rim for themselves and the selected hand rim can be assembled to the rim very easily, because the hand rim 5 can easily be attached or detached to or from the rim 1 by means of the connecting member 9.

In the above-mentioned embodiments, four pairs of plate-like shaped spokes 4 are used. However, the present invention is not limited to this embodiment; it is possible to use three pairs of plate-state spokes with 120 degrees therebetween to construct a wheel. The number of spokes is not limited to these examples. It may be possible to use more numbers of spokes in order to enhance the stiffness of the wheel.

As stated above, the manufacturing steps for the wheels are surprisingly fewer in comparison to the conventional wheel where spokes having a rod-like shape are used. Therefore, the productivity in manufacturing becomes better and the convenience in using is improved. Since it is not necessary to use a plurality of spokes having a rod-like shape, the freedom for designing the wheel as a whole becomes greater. Further, tubeless tires can be used. Furthermore, in the case that the wheel according to the invention is applied to a wheelchair, a suitable hand rim for the user can easily be assembled.

Moreover, according to the invention, since the spokes having a plate-like shape are detachable to the wheel, it is easy to alter the spokes arbitrarily. In addition to this, by selecting a suitable length of the hub in an axial direction, the tension of the spokes can easily be adjusted and then the tension and the spring effect of the wheel as a whole can be easily and arbitrarily altered.

What is claimed is:

1. A wheel comprising a rim for mounting a tire around thereof; a hub being located in a center of said rim, and a plurality of spokes having a plate-like shape being held between said rim and said hub.

2. A wheel according to claim 1, wherein said spokes having a plate like shape are arranged to be detachable to the rim and the hub.

3. A wheel according to claim 2, wherein said hub is adjustable in its axial direction.

4. A wheel according to claim 3, wherein said hub constitutes of a plurality of hub members having a different length in its axial direction, and wherein one of the hub members is selectively used so as to adjust the length of the hub in its axial direction.

5. A wheel according to claim 3, wherein said hub constitutes of a hollowed cylindrical member, and outer members being arranged on both sides of said hollowed cylindrical member in its axial direction, and wherein the length of the hub in its axial direction is adjusted by changing the position, at which said hollowed cylindrical member and said outer members are assembled together.

6. A wheel according to claim 1, wherein said rim comprises a plurality of protrusions on an inner circumference thereof for assembling a hand rim there.

7. A wheel according to claim 6, wherein a hand rim is assembled to said rim by means of connecting members.
